(19) United States
(12) Patent Application Publication
(10) Pub. No.: US 2005/0008463 A1
(43) Pub. Date: Jan. 13, 2005

(54) Order-picking storage system for picking transport units

(76) Inventors: Peter Stehr, Obertshausen (DE); Matthias Stotzner, Banbury (GB)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/863,948

(22) Filed: Jun. 9, 2004

(30) Foreign Application Priority Data
Jun. 12, 2003 (DE) 103 26 553.8

(51) Int. Cl. B65G 1/00

(52) U.S. Cl. 414/277

(57) ABSTRACT

An order-picking storage system for picking orders, in particular of articles in containers, includes at least one container store and at least one order-picking workplace. The containers are supplied from the container stores to at least one order-picking workplace and are provided there in straight-through channels and/or in variable-use stations in a plurality of removal positions. A conveying device transfers the containers supplied from the container store to each straight-through channel and/or variable-use station. The straight-through channels and/or variable-use stations and the order-picking workplace are arranged in the upper region of the container store. The storage system thus provides a time-saving and staff-saving order-picking storage system with a high utilization of space, and provides a compact, ergonomic and attractive workstation.

### FIELD OF THE INVENTION

The invention relates to an order-picking storage system for the static and dynamic provision and picking of transport units, in particular articles in containers.

### BACKGROUND OF THE INVENTION

In the picking of articles for orders, a distinction is substantially drawn between two article types, namely fast movers and slow movers. Fast movers are those articles which are needed frequently or in relatively large quantities, while slow movers are those articles which are needed seldom or in small quantities. It is known to arrange for the fast-moving articles to be picked directly from the pallet. For this purpose, the pallets are provided in the order-picking area; the picking is then carried out by the order-picking personnel. The picking of slow-moving articles is generally carried out from pallets in floor stores or in bin stores in accordance with the “man to goods” principle, that is to say the order picker goes to the appropriate stores and removes the desired articles. Small parts are usually stored and picked directly in bin stores, specifically likewise in accordance with the “man to goods” principle.

A comparatively high amount of space (area) is required for the above described storage of the articles. It is also thought to be disadvantageous that, when the order picking for a job is to be carried out by one and the same picker, the latter has to cover relatively long distances if the job comprises articles from the fast-mover and slow-mover areas, since he has to collate articles from a plurality of storage areas. On the other hand, if the jobs are processed only partly in the respective storage areas, that is to say the picking of the slow-moving articles and the fast-moving articles is carried out independently of one another and by different personnel, this means splitting the order-picking job and a higher potential error rate associated with this, and also additional expenditure in the subsequent assembly.

Furthermore, because of the storage of the fast-moving articles, on one hand, and the slow-moving articles, on the other hand, in different storage areas, a plurality of order-picking principles is necessary, such as “goods to man” and “man to goods”. This requires either the use of a plurality of order pickers specialized in the respective order-picking principle or else the order pickers have to learn a plurality of order-picking principles. This in turn means, firstly, a certain amount of inflexibility of the overall system and, secondly, requires higher qualification of the personnel. In the case of order picking from bin stores (in particular in the case of small parts), the result is a low order-picking reliability and, as a result, a comparatively high error rate.

In an order-picking storage system according to EP 0 847 939, provision is made to define the individual containers as fast-mover containers or as slow-mover containers, the individual straight-through channels being defined partly as straight-through channels for fast movers and partly as straight-through channels for slow movers. The fast-mover containers are supplied to the fast-mover straight-through channels and the slow-mover containers are supplied to the variable-use stations of the slow-mover straight-through channels. As soon as a fast-mover container located in the removal position has been emptied, it is removed from its removal position and a further fast-mover container located in the straight-through channel is brought into the removal position. The slow-mover containers are supplied to the variable-use stations (slow-mover straight-through channels) in such a way that there is always only a single slow-mover container at the variable-use station. Following removal of the desired articles from the slow-mover container, the still partly filled slow-mover container is transported back from the variable-use station to the container store and stored there.

A great disadvantage of the conventional order-picking systems is the space problem. Depending on the quantity of articles to be picked and therefore on the number of containers, even in the case of a relatively large number of storage levels and storage rows, the result is order-picking systems with considerable dimensions. Even if the containers are subdivided into the above described fast-mover containers and slow-mover containers and the order-picking storage system is largely automated in order to save the order pickers long distances, the space required for a comprehensive article store is often greater than the space available nowadays. The stores are therefore constructed to be as high as possible, the store rows are divided by very narrow store aisles. Nevertheless, for the part of the order-picking work to be carried out manually, depending on the required order-picking performance, order-picking workplaces are needed between the rows of racks, where one or more persons removes or remove the type and number of goods which the customer has ordered from the containers sorted by articles. These order-picking workplaces take up additional space, which is not available as storage area. It is easy to see that, in particular in the case of very high order-picking stores, what are known as high-rack (high-bay) stores, a considerable amount of storage space is lost, because no containers can be stored on and immediately above the order-picking workplaces. In addition, the workplaces are anything other than attractive because the order pickers frequently have to work less than ergonomically in a ravine between high rows of racks under artificial light.

### SUMMARY OF THE INVENTION

The present invention relates to an order-picking storage system for the static and dynamic provision and picking of transport units, in particular articles in containers, the containers being supplied by means of conveying devices from container stores having bins arranged beside one another in several rows of racks and in a large number of storage levels to at least one order-picking workplace and being provided there in straight-through channels and/or in variable-use stations in a plurality of removal positions located in the region of the order-picking workplace, each straight-through channel and/or variable-use station having, on its side facing away from the order-picking workplace, a transfer region to which a conveying device transfers the containers supplied from the container store.

The present invention also covers those order-picking stores in which other transport units such as trays, packs (cartons) etc. are used in order to store and to transport the goods to be picked.

It is an object of the present invention to reconfigure a time-saving and staff-saving order-picking storage system of the known type in such a way that, with high utilization of space, at the same time a compact, ergonomic and attractive workstation for high-performance fast-mover and slow-mover order picking is created with a high picking performance of the order pickers.

In order to achieve the object, the invention proposes that the straight-through channels and/or variable-use stations and the order-picking workplace of a generic order-picking storage system be arranged in the upper region of the container store.

In a departure from the otherwise conventional arrangement of the order-picking workplaces on the floor of the order-picking store, the present invention proposes to arrange the order-picking workplaces at the top in the region of the container store, generally underneath the roof of the order-picking store. There, an attractive work place illuminated by daylight, for example through roof lights or dormer windows, can be created, which no longer gives the order picker or the order pickers the impression of having to work in a narrow aisle or ravine.

A particular further advantage of the arrangement according to the invention of the order-picking workplaces is to be seen in the fact that, according to a further feature of the present invention, further bins of a container store are arranged underneath the order-picking workplace.

While, in order-picking storage systems according to the prior art, each order-picking workplace is arranged in an aisle between the rows of racks and this aisle has to be designed to be correspondingly wide, by means of the features of the present invention, such a wide aisle is no longer needed. Instead, the space saved can be used as a further container store, the order-picking workplace being placed at the top above this additional region of the container store. In this way, in particular in high-rack stores, a considerable additional amount of storage space is created, which is associated with the attractive arrangement of the order-picking workplace.

It is particularly beneficial if, according to a further feature of the present invention, the container store arranged underneath the order-picking workplace is part of an automatic order-picking device having at least two rows of racks and rack operating appliances arranged between these in a rack aisle.

According to a further feature of the present invention, provision is made for the static provision with access to fast-mover containers with high provision performance and the dynamic provision with access to slow-mover containers to be separated functionally from each other. As distinct from the prior art, where various straight-through channels can be defined for slow-mover or fast-mover containers as required, the present invention therefore provides for clear functional separation of the regions.

According to the present invention, provision is made for the static provision of fast-mover containers at the removal positions of the order-picking workplace to be carried out via the straight-through channels associated with the order-picking workplace, whose transfer regions can be served by rack operating appliances of the automatic order-picking device of the container store. In a manner known per se, via the straight-through channels, the rack operating appliances serve the removal positions at the order-picking workplace completely automatically, where fast-moving products, that is to say those products which are needed in a large quantity and in large numbers, are removed.

According to a further feature of the present invention, the dynamic provision of slow-moving containers is carried out at the removal positions of the dynamic variable-use stations of the order-picking workplace, whose transfer region can be served by lifting beams or vehicle systems, such as rack operating appliances. Preference is given to lifting beams which, with their working range over a plurality of storage levels and over a relatively large storage width, are capable of serving the variable-use stations with little effort and with a high performance.

In this case it is particularly beneficial if, according to a further feature of the present invention, the dynamic variable-use stations of the order-picking workplace are arranged above a row of racks having bins for the slow-mover containers, between which and a parallel adjacent row of racks the lifting beam of the conveying device (with which the transfer region of the dynamic variable-use stations can be served) can be moved. In other words, the lifting beam can be moved between adjacent rows of racks, which may have bins for the slow-mover containers. The slow-mover containers are thus arranged in the immediate vicinity of the dynamic variable-use stations and are served by the lifting beam, which removes the containers both from the bins arranged immediately underneath the order-picking workplace and from bins which are stored directly opposite in a second row of racks, which likewise lies within the access range of the lifting beam.

The order-picking storage system according to the present invention can of course comprise few racks with appropriate conveying devices, but the order-picking storage system preferably comprises a plurality of interlinked container stores having a plurality of order-picking workplaces arranged in their upper regions and associated straight-through channels and/or variable-use stations, which are assembled to form the order-picking storage system. All the equipment is constructed modularly and can be put together as desired and also expanded. By arranging the order-picking workplaces in the upper region of the container stores, considerable additional space is used, which was occupied by the order-picking workplaces in conventional order-picking storage systems and thus was not available as storage space.

It is particularly beneficial if the order-picking storage system comprises mutually parallel high racks with preferably double-depth container spaces at each storage level, storage aisles being formed between two high racks, in which there are arranged rack operating appliances for transporting the containers between their storage spaces and the transfer regions of the straight-through channels or the lifting beams of the variable-use stations. High-rack stores with very many storage levels are of course particularly suitable, since the space underneath the order-picking workplaces is particularly large and thus a considerably larger additional storage space is created. The transfer of the containers can be carried out directly to the straight-through channels by means of the rack operating appliances, but it is also conceivable to convey containers through free channels in the rows of racks into the range of the lifting beams, where they are accepted and stored in slow-mover regions. The spaces for providing fast-mover and slow-mover containers are in this way mutually interchangeable. The lifting beams used serve one or more workstations in an adaptive manner, depending on the required performance.

A particular advantage of the present invention is the considerably higher utilization of space which results from the arrangement of additional container storage spaces underneath the order-picking workplaces. The functional separation of the provision of fast-mover containers and slow-mover containers advantageously permits a mass store with access to the fast-mover containers with a moderate provision performance, preferably with the aid of an automatic order-picking storage system, and a highly dynamic provision with access to the slow-mover containers by means of a lifting beam. The use of a lifting beam increases the provision performance of the order-picking store considerably; this is because the lifting beam is faster than a rack operating appliance. A further advantage of the present invention is that the structure of the order-picking store according to the invention can be adapted in a modular fashion to the requirements. The present invention creates an extremely attractive daylight workstation for the order pickers, which has a positive effect on the picking performance.

These and other objects, advantages, purposes and features of the present invention will become apparent upon review of the following specification in conjunction with the drawings.

### BRIEF DESCRIPTION OF THE DRAWINGS

An exemplary embodiment of the invention is illustrated in the drawings, in which:

FIG. 1 is a perspective illustration of an order-picking storage system according to the present invention;

FIG. 2 is a side view of an order-picking storage system according to the present invention; and

FIG. 3 is a plan view of a region of the order-picking store according to the present invention, with two order-picking workplaces.

### DESCRIPTION OF THE PREFERRED EMBODIMENTS

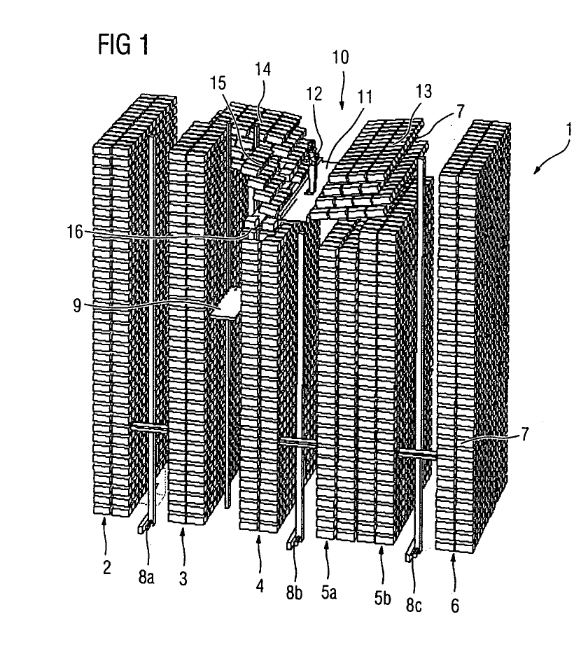

In FIG. 1, a region of an order-picking storage system typical of the present invention is designated generally by 1. The illustration in the drawing has been chosen to be perspective and, in a highly schematic illustration, shows a container store comprising a plurality of rows 2-6 of racks, in which the containers, of which one of the containers is numbered 7, are stored. Between the rows of racks 2 and 3, 4 and 5a and also 5b and 6, in each case rack operating appliances 8a to 8c can be moved, which can engage in the container storage spaces formed at double depth on both sides of the storage aisles formed between the rows of racks and can remove and replace containers there.

Between the rows 3 and 4 of racks, in a region of the storage aisle, there moves a lifting beam 9, which can remove containers 7 from the respective front row of racks facing the lifting beam and can set them down again there. As can be seen in FIG. 1, 10 designates an order-picking workplace which, according to the invention, is arranged in the upper region of the order-picking storage system 1. The order-picking workplace 10 substantially comprises a platform 11, on which an order picker 12 stands, and straight-through channels 13 arranged on both sides of the platform 11, and also variable-use stations 15 on the left-hand side of the platform 11. Those articles which are needed in a large quantity and at short time intervals (fast movers) are kept ready in the straight-through channels 13 and 14 on sloping shelves. The containers 7 are emptied one after another by the order picker. The emptied containers are transported away for refilling via an output transport belt 16, while newly filled fast-mover containers are fetched from one of the rows 2, 3, 5b or 6 of racks and supplied to the straight-through channel 13 or 14 in the region of the transfer point.

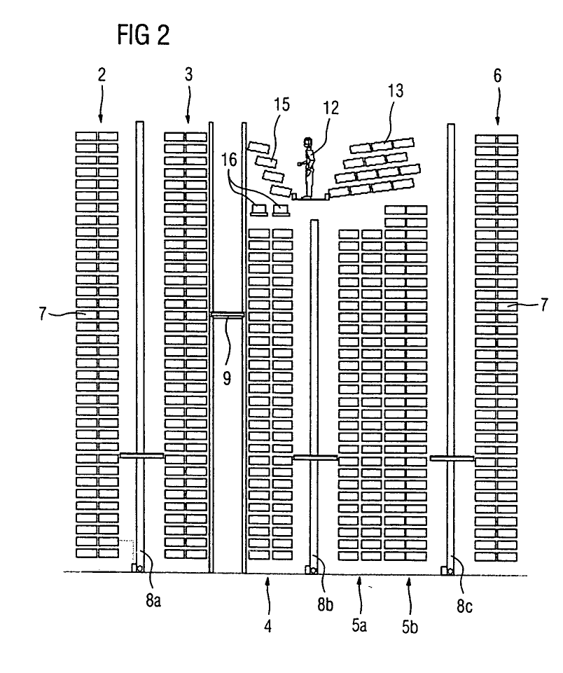

As illustrated more clearly in FIG. 2 of the drawing in a cross section through the order-picking storage system according to FIG. 1, additional rows 4 and 5a of racks are arranged underneath the order-picking workplace 10, filling up the free space underneath the order-picking workplace 10. The rack operating appliance 8c is capable of transferring containers from the right hand half of the row 5b of racks to the transfer region of the straight-through channels 13; the rack operating appliance 8b can thread the additionally stored containers into the system.

Underneath the variable-use stations illustrated at 15, two conveyors 16 for transporting empty and picked containers 7 are provided. At the same time, immediately underneath the variable-use station 15 in the left-hand half of the row 4 of racks, further container spaces for slow-mover containers are provided and are served by the lifting beam 9. The lifting beam 9 also serves the right-hand half of the row 3 of racks, in which slow-mover containers are likewise deposited. Using the lifting beam 9, the variable-use stations 15 can be served very quickly and dynamically, it being possible for the containers 7 provided temporarily at the variable-use stations to be guided back into their storage spaces following the removal of articles to be picked for an order.

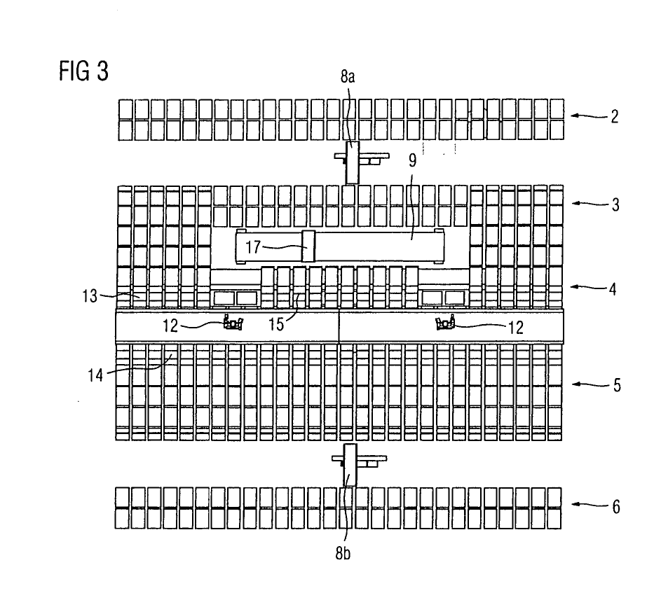

In FIG. 3 of the drawings, the arrangement of the straight-through channels 13 and 14 and of the variable-use stations 15 can be seen once more in a plan view of part of the order-picking storage system. The two rack operating appliances which can be seen are designated 8a and 8b in accordance with FIGS. 1 and 2. They can be moved in their longitudinal direction in the storage aisles between the rows 2 and 3 and also 5b and 6 of racks and, by means of telescopic pick-up devices, are capable of picking up and replacing the containers 7 stored to a twofold depth. A pick-up and transfer carriage 17 can be displaced in the horizontal direction along the vertically movable lifting beam 9. The carriage 17 can easily remove deeply stored containers 7 from the rows 3 and 4 of racks and transfer them to one of the variable-use stations 15. In the removal positions, the order pickers 12 pick up the articles which are stored in the containers and assemble them to form the order desired by the customer. As can be seen in FIG. 3, the straight-through channels 13 and 14 of part of the fast-mover containers reach over the rack aisle formed between the rows 3 and 4 of racks. The straight-through channels are served by the rack operating appliance 8a. The slow-mover containers positioned on both sides of the lifting beam 9 in the rows 3 and 4 of racks are stored and removed from store and transferred to the variable-use stations 15 by the transfer carriage 17 of the lifting beam. The lifting beam 9, as can be seen, in each case serves the workplaces of two order pickers 12; a further increase in the order-picking performance of the slow-mover containers is conceivable if two lifting beams are provided and in each case one lifting beam is assigned to one of the order-picking workplaces.

Changes and modifications to the specifically described embodiments may be carried out without departing from the principles of the present invention, which is intended to be limited only by the scope of the appended claims, as interpreted according to the principles of patent law.

1. An order-picking storage system for the static and dynamic provision and picking of transport units, in particular articles in containers, the containers being supplied by means of conveying devices, said order-picking storage system comprising:
at least one container store, said container stores having bins arranged beside one another in several rows of racks and in a large number of storage levels; and
at least one order-picking workplace, the containers being supplied from said container stores to said at least one order-picking workplace and being provided there in at least one of (a) straight-through channels and (b) variable-use stations, the containers being provided in a plurality of removal positions located in the region of said order-picking workplace, each of said at least one of (a) straight-through channels and (b) variable-use stations having, on its region facing away from said order-picking workplace, a transfer region to which a conveying device transfers the containers supplied from said container store, wherein said at least one of (a) straight-through channels and (b) variable-use stations and said order-picking workplace are arranged in the upper region of said container store.

2. The order-picking storage system as claimed in claim 1, wherein further bins of a container store are arranged underneath the order-picking workplace.

3. The order-picking storage system as claimed in claim 2, wherein said container store arranged underneath the order-picking workplace is part of an automatic order-picking device having at least two rows of racks and a rack operating appliance arranged between these in a rack aisle.

4. The order-picking storage system as claimed in claim 1, wherein the static provision with access to fast-mover containers with high provision performance and the dynamic provision with access to slow-mover containers are separated functionally from each other.

5. The order-picking storage system as claimed in claim 4, wherein the static provision of fast-mover containers at the removal positions of said order-picking workplace is carried out via said straight-through channels associated with said order-picking workplace, whose transfer regions can be served by rack operating appliances of an automatic order-picking device of said container store.

6. The order-picking storage system as claimed in claim 4, wherein the dynamic provision of slow-mover containers is carried out at the removal positions of the dynamic variable-use stations of said order-picking workplace, whose transfer regions can be served by lifting beams or rack operating appliances.

7. The order-picking storage system as claimed in claim 6, wherein the dynamic variable-use stations of said order-picking workplace are arranged above a row of racks having bins for the slow-mover containers, the lifting beam of the conveying device is movable between said row of racks and a parallel adjacent row of racks, the transfer region of the dynamic variable-use stations can be served by the lifting beam of the conveying device.

8. The order-picking storage system as claimed in claim 7, wherein a plurality of interlinked container stores having a plurality of order-picking workplaces arranged in their upper regions and associated said at least one of (a) straight-through channels and (b) variable-use stations are assembled to form said order-picking storage system.

9. The order-picking storage system as claimed in claim 6, wherein the order-picking storage system comprises mutually parallel high racks with double-depth container spaces at each storage level, rack aisles being formed between two of said high racks, in which there are arranged rack operating appliances for transporting the containers between their storage spaces and the transfer regions of the straight-through channels or the lifting beam of the variable-use stations.

10. The order-picking storage system as claimed in claim 1, wherein a plurality of interlinked container stores having a plurality of order-picking workplaces arranged in their upper regions and associated said at least one of (a) straight-through channels and (b) variable-use stations are assembled to form said order-picking storage system.

11. The order-picking storage system as claimed in claim 1, wherein the static provision of fast-mover containers at the removal positions of said order-picking workplace is carried out via the straight-through channels associated with said order-picking workplace, whose transfer regions can be served by rack operating appliances of the automatic order-picking device of said container store.

12. The order-picking storage system as claimed in claim 1, wherein the dynamic provision of slow-mover containers is carried out at the removal positions of the dynamic variable-use stations of the order-picking workplace, whose transfer regions can be served by lifting beams or rack operating appliances.
